(19) United States
(12) Patent Application Publication
(10) Pub. No.: US 2016/0112615 A1
(43) Pub. Date: Apr. 21, 2016

(54) APPARATUS AND PROCESSES FOR A MOBILE DEVICE CASE WITH FRONT FACING ILLUMINATION

(71) Applicants: Cori Elizabeth Consevage, Dallas, TX (US); Jason Wirt, Dallas, TX (US); Joseph Mond, Dallas, TX (US)

(72) Inventors: Cori Elizabeth Consevage, Dallas, TX (US); Jason Wirt, Dallas, TX (US); Joseph Mond, Dallas, TX (US)

(21) Appl. No.: 14/886,197

(22) Filed: Oct. 19, 2015

Related U.S. Application Data
(63) Continuation of application No. 62/065,299, filed on Oct. 17, 2014.

(51) Int. Cl. H04N 5/225; H04B 1/3888; F21V 23/02

(52) U.S. Cl. CPC H04N 5/2256; F21V 23/02; H04N 5/2251; H04B 1/3888; F21Y 2101/02

(57) ABSTRACT

A mobile device case containing one or more light bulbs is provided for use in providing illumination. More specifically, the invention relates to a mobile device case that contains, retractable light emitting diodes (LED lights) useful for the purpose of illumination for taking still image photography and/or motion pictures.

### CROSS REFERENCE TO RELATED APPLICATION

This application claims the benefit of U.S. Pat. No. 62/065,299 filed Oct. 17, 2014, the contents of which are hereby expressly incorporated by reference thereto for all purposes.

### FIELD OF INVENTION

The invention relates to apparatus and processes useful for providing front facing illumination in connection with a mobile device case. More specifically, the invention relates to a mobile device case that contains forward-facing, light emitting diodes (LED lights) useful for the purpose of illumination for taking still image photography and/or motion pictures.

### BACKGROUND OF THE INVENTION

Technological advances have made it commonplace for an individual to take photographs and/or video using a mobile device, such as a smartphone, phablet, or tablet. Individuals have come to favor mobile devices for photograph and videography over cameras and video recorders for any number of reasons, such as, for example, the ease in carrying one device that can take high quality (high definition) photographs and/or video that are on par with or exceed the quality of standalone cameras and/or video recorders. Consequently, mobile device use to take photographs and video has become prevalent.

Photograph and video technology has advanced to include capabilities to capture regular and high definition imagery. There is an age old problem with photography and/or videography that persists even with the advancement in technology, namely, proper illumination for the subject, and particularly, effective illumination in low light and dark environments.

Mobile devices generally include rear facing and front facing cameras for taking photographs and video footage. For reference, the phrase “rear facing” is used in reference to the direction that is generally perpendicular to the rear face of a mobile device (e.g., the side that does not have the user interface). The phrases “front facing” or “forward facing” is used in reference to the direction that is generally perpendicular to the front face of a mobile device (e.g., the side with the user interface). One particular problem with mobile devices is the limited front facing surface that can be used. Mobile device manufacturers tend to optimize the front facing user interface and include a front facing camera without a flash or other light source, while providing a flash or similar lighting mechanism that emits light from the rear facing surface of the mobile device. Therefore, mobile device users are limited to using the rear facing camera to take photographs and/or video in low light settings or in the dark. Consequently, mobile device users cannot take high quality photographs and/or video from the front facing camera in low light settings or in the dark.

Thus, there is a need for a mobile device case that provides forward facing illumination that is not provided by mobile devices or mobile device cases in order to provide proper lighting for photo and/or video footage taken by forward facing cameras on a mobile device.

### DESCRIPTION OF THE FIGURES

Additional aspects, features, and advantages of the invention, as to its structure, assembly and use, will be understood and become more readily apparent when the invention is considered in light of the following description of illustrative embodiments made in conjunction with the accompanying drawings, wherein:

FIG. 1 is a front perspective view of an embodiment of the mobile device case with the retractable devices retracted to their closed positions.

FIG. 2 is a rear perspective view of an embodiment of the mobile device case with the retractable devices retracted to their closed positions.

FIG. 3 is a rear perspective view of an embodiment of the mobile device case with the retractable devices retracted to their closed positions.

FIG. 4 is a rear view of an embodiment of the mobile device case with the retractable devices retracted to their closed positions.

FIG. 5 is a top view of an embodiment of the mobile device case with the retractable devices retracted to their closed positions.

FIG. 6 is a bottom view of an embodiment of the mobile device case with the retractable devices retracted to their closed positions.

FIG. 7 is a right side view of an embodiment of the mobile device case with the retractable devices retracted to their closed positions.

FIG. 8 is a left side view of an embodiment of the mobile device case with the retractable devices retracted to their closed positions.

FIG. 9 is a rear view of an embodiment of the mobile device case with the retractable devices retracted to their closed positions.

FIG. 10 is a rear perspective view of an embodiment of the mobile device case with the retractable devices retracted to their closed positions.

FIG. 11 is a bottom view of an embodiment of the mobile device case with the retractable devices retracted to their closed positions.

FIG. 12 is a right side view of an embodiment of the mobile device case with the retractable devices retracted to their closed positions.

### DESCRIPTION OF EMBODIMENTS OF THE INVENTION

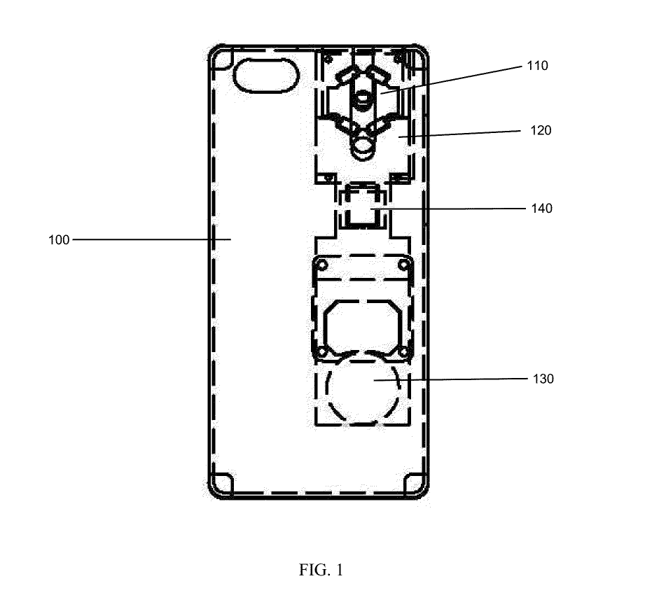

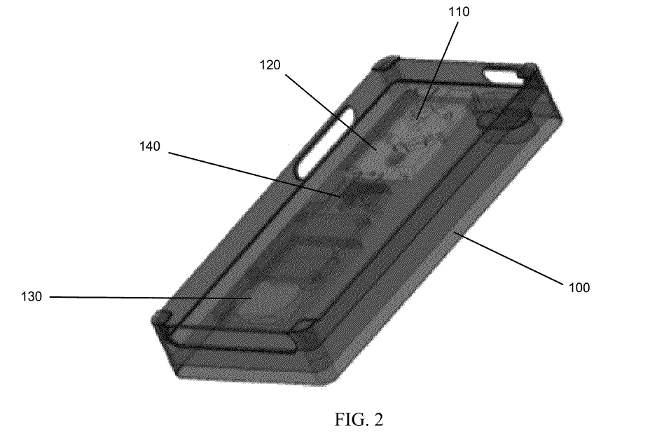

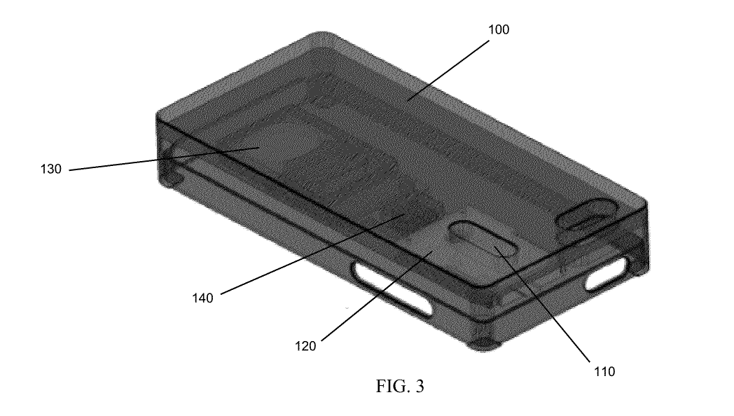

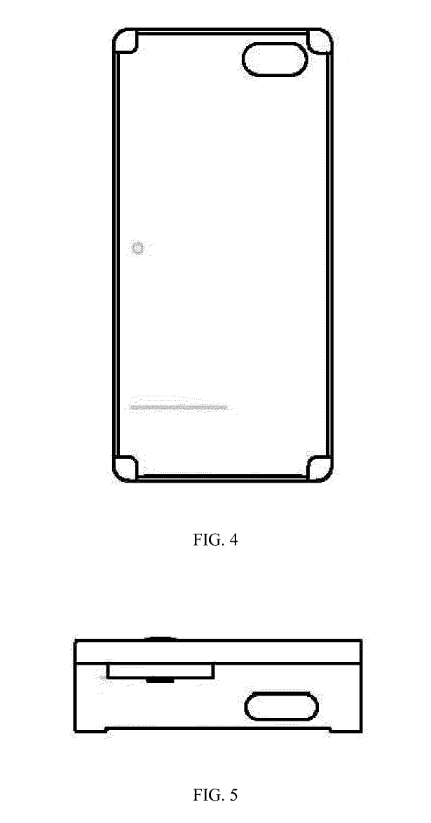

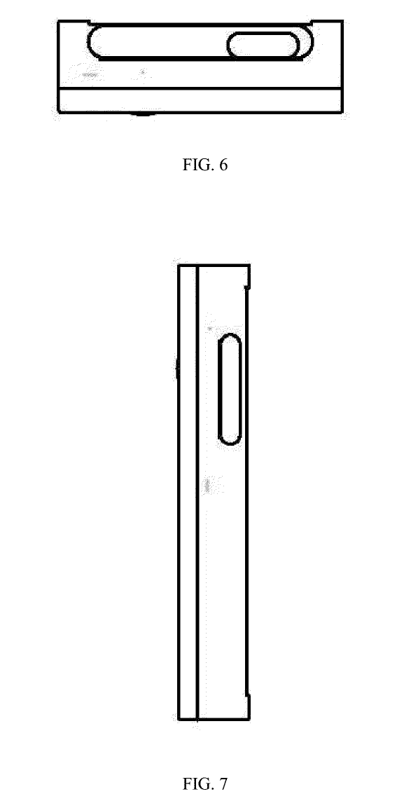

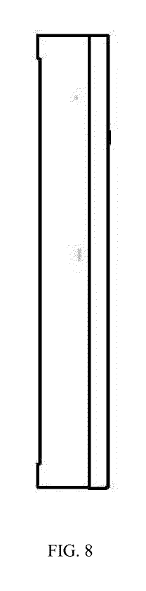

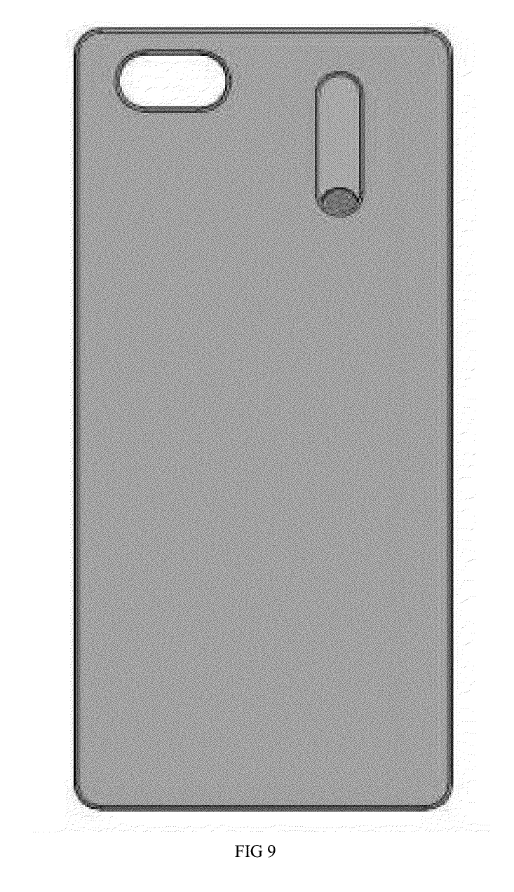

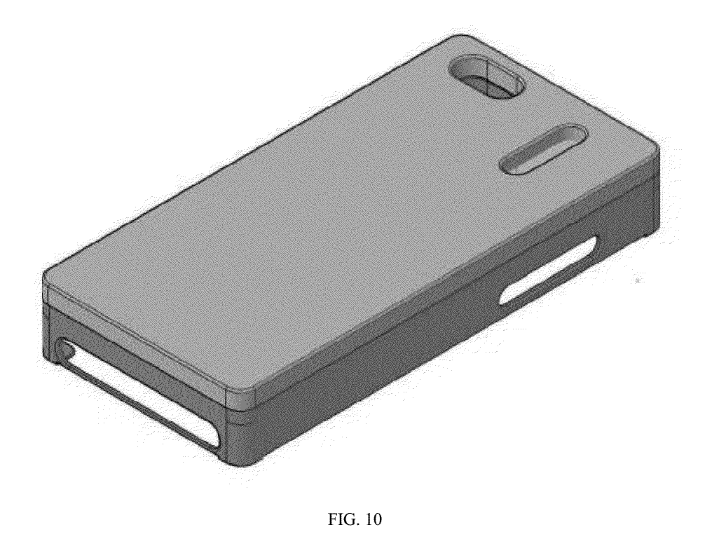

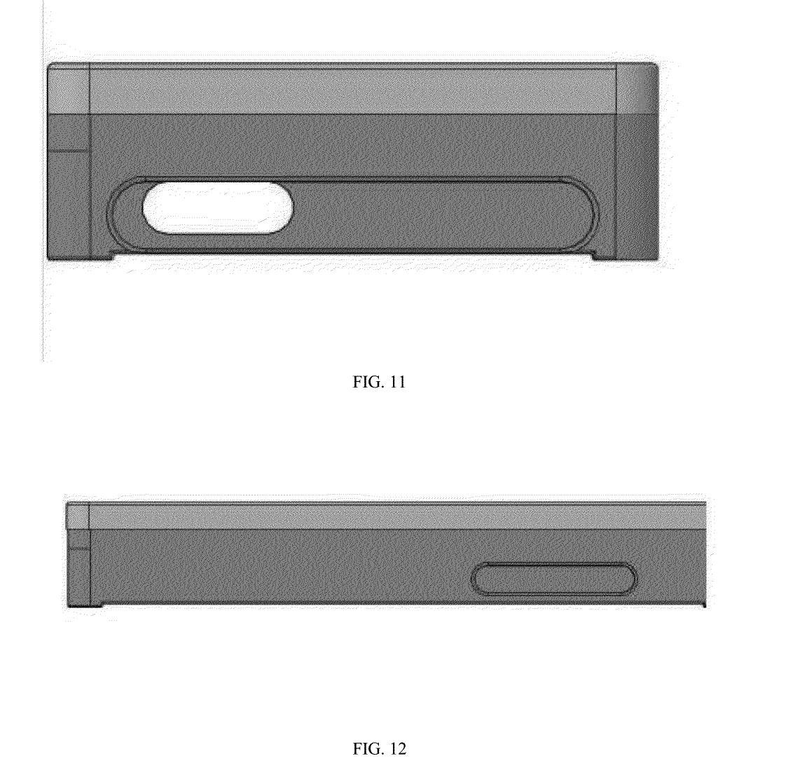

Illustrative and alternative embodiments of a mobile device case that contains either fixed or retractable LED (or other) light(s) to act as an illuminator for a front or rear facing camera on a mobile device is described in detail, as follows, with reference to FIGS. 1-12 of this disclosure. Although similar aspects of embodiments are featured throughout this disclosure and are readily apparent, these similarities may be repeated within the context of the various embodiments of the invention.

The mobile device case comprises a protective outer shell (case), 100, in one or more pieces to allow easy removal of a mobile device from the case, an optional adapter to connect to the power supply of the mobile device and/or an external power supply located in the body of the case, and one or more LED (or other) light(s), 110, mounted on one or more retractable pieces on the vertical sides of the case and/or horizontally along the top edge of the case, 120. The power for the LED (or other) light(s) may be provided by: (1) the mobile device's battery via a mobile adapter located on each device, and/or (2) an external power source, 130, located either (a) inside the protective shell or (b) outside of the shell of the case connected to both the cellular device's internal power source or to just the light emitting portion, 140. The retractable piece(s) containing the functional portion of the case, LED (or other) light(s), may be configured to retract flushly into the body of the mobile device case via the touch of a finger due to a spring loaded or other biasing mechanism.

The mobile device case has a protective portion. The precise construction of the protective portion is not critical, nor are the materials from which it is made. The case may comprise different shapes and dimensions so as to fit various-shaped mobile devices including, but not limited to, smartphones, tablets, phablets, and personal digital assistant. The case is preferably substantially rigid, light weight, durable, and impact resistant. It can be made of polycarbonate, plastic, carbon fiber, silicone, metal, alloy, leather, or other materials that can provide sufficient protection for the mobile device against scratches, bumps, drops, and other damages. The case has a plurality of openings to permit full vision, touch and use of the mobile device's screen, cameras, and buttons and ports. The case may consist of one or more retractable pieces that can be operationally coupled to receive the mobile device and be easily removed from the mobile device. The retractable pieces can be locked into the case when not in use.

In an embodiment, the case has an front portion and a rear portion which if engagingly coupled to the mobile device can secure the mobile device within the case. It can further include detachable caps to cover the ports and buttons when not in use so as to protect the them from malfunctions caused by dirt and liquid. All the ports and buttons are accessible when the caps are detached.

The number, dimension, and the type of the lights provided in connection with the mobile device case are not critical so long as they provide sufficient illumination of the subject of the photograph and/or video in low light settings or in the dark. In various embodiments, the lights can be LEDs, incandescent bulbs, fluorescent bulbs, halogen bulbs, high intensity discharge (HID) bulbs, Low pressure sodium bulb, or other types of light bulbs. However, the preferred light is one or more LEDs because LEDs require less power than other lights, as well as produce less heat during operation, and have a long life span.

The lights can be mounted in the mobile device case to face the same direction as the rear of the mobile device secured in the mobile device case. In this configuration, the rearward facing lights can supplement insufficient illumination produced by the integrated light of the mobile device.

However, the lights may also be preferably mounted in the mobile device to face the same direction as the front of a mobile device secured in the mobile device case. Mobile devices lack front facing illumination with the front facing camera. In this embodiment, the lights provide illumination for front facing cameras of the mobile device to allow the camera operator to see themselves and/or others on the screen while taking a photograph(s) and/or video(s).

In embodiments, the lights may be fixed along the edge(s) of the case, but may also be mounted on one or more retractable devices that articulate into and out of the case. In one embodiment, the lights are mounted on two retractable square pieces on the left and right edges of the case, respectively. The retractable pieces can articulate between a deployed position and a concealed position inside the case.

In an alternative embodiment, lights are mounted on retractable triangular pieces that rotate around a pivot mechanism, such as a pin, or other set of corresponding prongs/detents within the side of the case. In this embodiment, the retractable pieces can articulate between a deployed position and a concealed position inside the case.

In a further embodiment, as shown in FIGS. 1, 2 and 3, lights are mounted on retractable rectangular pieces that that articulate into and out of the case. In this embodiment, the lights are mounted on retractable rectangular pieces on the left, right, and/or top edges of the case, respectively. The retractable pieces can articulate between a deployed position and a concealed position inside the case.

In an even further embodiment, lights are mounted on a retractable rectangular piece on the top edge of the case. The retractable piece can articulate between a deployed position outside of the case and a concealed position within the top edge of the case.

Alternative configurations of retractable pieces, including different shapes and articulation mechanisms can be used.

The lights are preferably positioned in a manner that the lights, in aggregation, can direct illumination at an angle of about 45 degrees to about 90 from the front surface of the mobile phone device. The specific angles depend on the desired light intensity and range for a camera. In an embodiment, the lights may direct illumination in a single direction (e.g., directly away from the front facing surface of the mobile device case). In an alternative embodiment, the lights may direct illumination in different directions (e.g., some directly away from the front facing surface of the phone while others angled from the front facing direction).

The retractable device can be operated using an automatic system (such as, a spring-loaded or other biasing member), semi-automatic system, or manually. In the embodiments, as shown in FIGS. 1 to 12, the mobile device case has retractable pieces on the top of the case, which can be extended out of the case with the force of springs when a user pushes a release button(s) on the case that releases locks securing the retractable pieces within the mobile device case. When the user wants to store the retractable pieces, the user can press the retractable pieces against the force of the springs and the retractable pieces will be locked at their closed positions with the lock. The springs can be disposed in channels such that they extend and compress along the axis of the channels within the mobile device case.

The construction of the lock and the dimension of the retractable pieces are not critical as long as the retractable pieces can be completely retracted and locked inside the case. In another embodiment, the retractable pieces have handles by which the retractable pieces can be manually operated. The construction of the handles are not critical so long as they allow a user to pull the retractable pieces out of the case from their closed positions to deployed positions.

Power can be provided to the lights by batteries, 130, mounted within the mobile device case, batteries external to the case, or the internal power supply of the mobile device. The batteries can be button batteries, solid lithium ion flat batteries, or other suitable small size batteries. The batteries can be either rechargeable or disposable. In a preferred embodiment, as shown in FIG. 1 the mobile device case has a built-in battery assembly consisting of one or more batteries normally used for watches or computer motherboards. In other embodiments, the battery assembly can also be located outside the case and removably attached to both the lights and the internal power source of the device, such that the amount and/or dimension of the batteries can be increased to not only provide more power to the lights but also charge the mobile device when connected. Alternatively, the built-in battery assembly can be replaced by an adapter which can be removably attached to the charging port of the mobile device to power the lights with the internal power source of the mobile device.

The power source can be connected to the lights through a printed circuit board (PCB) embedding electronic components such as resistors, capacitors, transistors, relays, and integrated circuits. Specific design of the PCB can vary in accordance with the amount and parameters of the lights and other electronic components on the PCB. For instance, strings of LEDs are normally connected in series and each LED divides a portion of the source voltage. For this reason LEDs in series always require a high source voltage from the power supply. However, if the parameters of the LEDs are nearly identical, the LEDs can be connected in parallel such that each LED will receive the total voltage that the power supply is outputting so that a lower source voltage will suffice. Despite such an advantage, wiring in parallel drains batteries faster than wiring in series, thus more suitable for high capacity batteries.

When a user wants to take a front facing photograph or video, the user can push an activation button on the case, then the activation button activates a relay which allows the power to transfer from either the battery assembly or the internal power of the mobile device to the lights through the PCB thereby activates the lights. When the lights are no longer needed, they can be turned off by pushing the same button, which then cuts off the power and extinguishes the lights. In an alternative embodiment, releasing the lock securing the retractable pieces can also cause a contact to be formed and automatically transmit power to the lights.

In other embodiments, the lights may be wirelessly controlled by the mobile device so that use of the lights can be synched with the photograph or video being shot. For example, the lights may turn on when the camera is taking a photograph or video and may turn off when the camera is no longer taking the photograph or video.

Operability of the lights may involve (1) constant illumination when the power is turned on the lights, (2) sequential flash impulses when the power is turned on, or (3) either (1) or (2) if the illumination is synched with the camera on the mobile device or other sequential flashing sequence typical for removing “red eye” from the subject(s) being photographed or videoed.

While the invention has been described above in conjunction with specific embodiments, it is evident that many alternatives, modifications, permutations, and variations will become apparent to those skilled in the art in light of the foregoing description. Accordingly, it is intended that the present invention embraces all such alternatives, modifications, and variations as fall within the scope of the claims below.

We claim:

1. A mobile device case comprising:
a one or more light bulbs that emit light when power is supplied to the said light bulbs, wherein said one or more lights are affixed on or in said mobile device case; and
a power source to provide power to illuminate said one or more lights;
wherein said one or more lights are positioned relative to said mobile device case to direct illumination away from a front of said mobile device case, and wherein said illumination is configured to aid in image capture of a forward facing camera of a mobile device positioned within said mobile device case.

2. The mobile device case of claim 1 wherein said one or more lights bulbs comprise any one or more of an incandescent bulb, a light emitting diode (LED), a fluorescent bulb, a halogen bulb, or a high intensity discharge (HID) bulb.

3. The mobile device case of claim 2 wherein said light bulbs are provided as a series of lights.

4. The mobile device case of claim 1 wherein said light bulbs are embedded within said mobile device case.

5. The mobile device case of claim 1 comprising one or more retractable devices have said one or more lights embedded therein, wherein said one or more retractable devices are configured to move from a closed position within a receiving area of the case to an deployed position whereby said one or more lights are exposed to emit light.

6. The mobile device case of claim 5 comprising a retractable device.

7. The mobile device case of claim 5 comprising two or more retractable devices.

8. The mobile device case of claim 5 wherein said one or more retractable devices comprise a lock mechanism with a release.

9. The mobile device case of claim 5 wherein said one or more retractable devices comprise a lock mechanism with a release and a bias member configured to move said one or more retractable devices to said deployed position when said lock mechanism is released.

10. The mobile device case of claim 1 wherein said power source is provided within said mobile device case or by an external source.

11. The mobile device case of claim 10 wherein said power source comprises one or a series of batteries removably embedded within said mobile device case.

12. The mobile device case of claim 1 wherein said one or more lights are configured to illuminate an area equal to or greater than a foot.

13. The mobile device case of claim 1 wherein said one or more lights are positioned to direct illumination at an angle of about 45 degrees to about 90 degrees from said front of said mobile device case when said one or more lights are powered by said power source.

14. The mobile device case of claim 13 wherein said angle is the same for said one or more lights.

15. The mobile device case of claim 13 wherein said angle is different for said lights if more than one light is provided with said mobile device case.

16. The mobile device case of claim 15 wherein said lights are configured to direct illumination away from said front of said mobile device case at said angles that are 45 degrees and 90 degrees.

17. The mobile device case of claim 15 wherein said lights are configured to direct illumination away from said front of said mobile device case at angles that are 45 degrees and 90 degrees, as well as angles in between 45 degrees and 90 degrees.

18. The mobile device case of claim of 13 where said one or more lights can be manipulated to direct illumination away from said front of said mobile phone device at any angle from said front from about 45 degrees to about 90 degrees.
